(19) United States
(12) Patent Application Publication
(10) Pub. No.: US 2002/0101882 A1
(43) Pub. Date: Aug. 1, 2002

(54) Transmission of voice and information signals in a single line

(76) Inventor: Man-Duck Kim, Seoul (KR)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/863,864

(22) Filed: May 21, 2001

(30) Foreign Application Priority Data
Aug. 5, 2000 (KR) 20-2000-0022380

(51) Int. Cl. H04J 3/16; H04L 12/66

(52) U.S. Cl. 370/480; 370/465; 370/352

(57) ABSTRACT

This invention relates to a signal processing apparatus. The apparatus comprises a first circuit and a second circuit having an output terminal, respectively. The first circuit is configured to receive a first signal comprising a first frequency band and pass a component of the first signal having a higher frequency than a first predetermined frequency. The second circuit is configured to receive a second signal comprising a second frequency band overlapping with at least a portion of the first frequency band. Also, the second circuit is configured to pass a component of the second signal having a lower frequency than a second predetermined frequency. Here, the output terminal of the first circuit is connected to the output terminal of the second circuit. According to the invention, the voice and the data can be transmitted through the single transmission line.

### RELATED APPLICATIONS

This application is related to four U.S. patent applications Nos. (not assigned), filed concurrently herewith and entitled, “Transmission of Voice and Information Signals Using Power Reduction of Information Signal”, “Digital Subscriber Line Modem”, “Computer System including Digital Subscriber Line Modem” and “Transmission of Voice and Information Signals Using Echo Cancellation”, which are hereby incorporated by reference herein. This application claims the benefit of Korean Application No. 20-2000-0022380 filed on August 5, 2000.

### BACKGROUND OF THE INVENTION

Field of the Invention

This invention relates to transmission of voice and information signals in a single line, and more particularly to simultaneous two-way transmission of voice and information signals by processing multiplexing the signals.

Description of the Related Technology

Digital Subscriber Line, or DSL, is a technology for transmitting high-bandwidth data to homes and small businesses over standard copper telephone lines. xDSL refers to the family of digital subscriber line technologies, such as ADSL (Asymmetric DSL), SDSL (Symmetric DSL), HDSL (High bit-rate DSL) and VDSL (Very high data rate DSL).

ADSL is called “asymmetric” because most of its two-way bandwidth is devoted to the downstream direction towards the user and only a small portion of bandwidth is available for upstream or user-interaction messages. One can have telephone conversations while transmitting data without requiring a separate line by using ADSL.

Meanwhile, SDSL is called “symmetric” because the transmission rate is the same in both downstream and upstream directions. SDSL is appropriate in situations when both uploading and downloading of significant size of data are required. In SDSL, however, voice and data cannot be transmitted at the same time. Therefore, the symmetric DSL groups such as SDSL, HDSL, etc., require a separate telephone line for data communication.

### SUMMARY OF CERTAIN INVENTIVE ASPECTS

One aspect of the present invention is to provide a signal processing apparatus. The apparatus comprises a first circuit and a second circuit having an output terminal, respectively. The first circuit is configured to receive a first signal comprising a frequency band and pass a component of the first signal having a higher frequency than a first predetermined frequency. The second circuit is configured to receive a second signal comprising a frequency band overlapping with at least a portion of the frequency band of the first signal. Also, the second circuit is configured to pass a component of the second signal having a lower frequency than a second predetermined frequency. Here, the output terminal of the first circuit is connected to the output terminal of the second circuit.

Another aspect of the present invention is to provide a method of processing a signal for transmitting via a transmission line. The method comprises receiving a first signal comprising a frequency band and receiving a second signal comprising a frequency band overlapping with at least a portion of the frequency band of the first signal. Also, the method comprises passing a component of the first signal having a higher frequency than a first predetermined frequency and passing a component of the second signal having a lower frequency than a second predetermined frequency. The method comprises combining the components of the first and second signal onto the transmission line.

Another aspect of the present invention is to provide a modem. The modem comprises a line transformer. The line transformer has an air gap. The line transformer is configured to receive a first signal and substantially reduce power of a component of the first signal. The component has a lower frequency than a first predetermined frequency.

Another aspect of the present invention is to provide a signal for being transmitted through a transmission line. The signal comprises a first signal and a second signal. The first signal has a first frequency band. The second signal has a second frequency band that does not substantially overlap with the first signal. The second signal is full-duplexed and at least of a portion of the second signal is reduced to avoid interference with the first signal. Here, the first signal is combined in the reduced portion of the second signal by frequency division multiplexing before transmission.

Another aspect of the present invention is to provide a signal processing apparatus. The apparatus comprises a first circuit, a second circuit and an echo canceller. The first circuit and the second circuit has an output terminal, respectively. The output terminals of the first and second circuits are connected each other. The first circuit is configured to receive a first signal and pass a component of the first signal having a higher frequency than a first predetermined frequency. The second circuit is configured to receive a second signal and pass a component of the second signal having a lower frequency than a second predetermined frequency. The echo canceller is configured to cancel a secondary signal generated by reflection of the first signal transmission.

Another aspect of the present invention is to provide a method of processing a signal for transmitting via a transmission line. The method comprises receiving a first signal having a first frequency band and receiving a second signal comprising a frequency band overlapping with at least a portion of the frequency band of the first signal. Also, the method comprises passing a component of the first signal, the component having a higher frequency than a first predetermined frequency and passing a component of the second signal, the component having a lower frequency than a second the predetermined frequency. The method comprises combining the component of the first signal and the component of the second signal onto the transmission line. Also, the method comprises performing cancelling a secondary signal returned by reflection of the first signal transmission.

### BRIEF DESCRIPTION OF THE DRAWINGS

The present invention will be understood and appreciated from the following detailed description, in conjunction with the accompanying drawings in which:

FIG. 1A is a general block diagram of a typical ADSL system.

FIG. 1B is a power spectrum of the typical ADSL system shown in FIG. 1A.

FIG. 2 is a general block diagram of a typical SDSL system.

FIG. 3 is a power spectrum of the SDSL system shown in FIG. 2.

FIG. 4 is a conceptual power reduction of data signals at low frequencies.

FIG. 5 is Power distribution spectrums of a DSL system at three different transmission rates.

FIGS. 6A and 6B are conceptual diagrams of upstream and downstream data transfer in one embodiment of the present invention.

FIGS. 7A and 7B are block diagrams of the user and network modems explaining the upstream operation according to one embodiment of the invention.

FIGS. 8A and 8B are block diagrams of the user and network modems explaining the downstream operation according to one embodiment of the invention.

FIG. 9 is an example circuit structure of the line transformer block used in the user and network modems shown in FIGS. 7A-8B.

FIG. 10 is a graph of impedance curves for two exemplary line transformer blocks.

FIGS. 11 and 12 are block diagrams of the user and network modems explaining the upstream and downstream operations according to another embodiment of the invention.

FIG. 13 is a power spectrum chart showing a transmission using FDM and ECM in a single transmission line.

### DETAILED DESCRIPTION OF THE CERTAIN INVENTIVE EMBODIMENTS

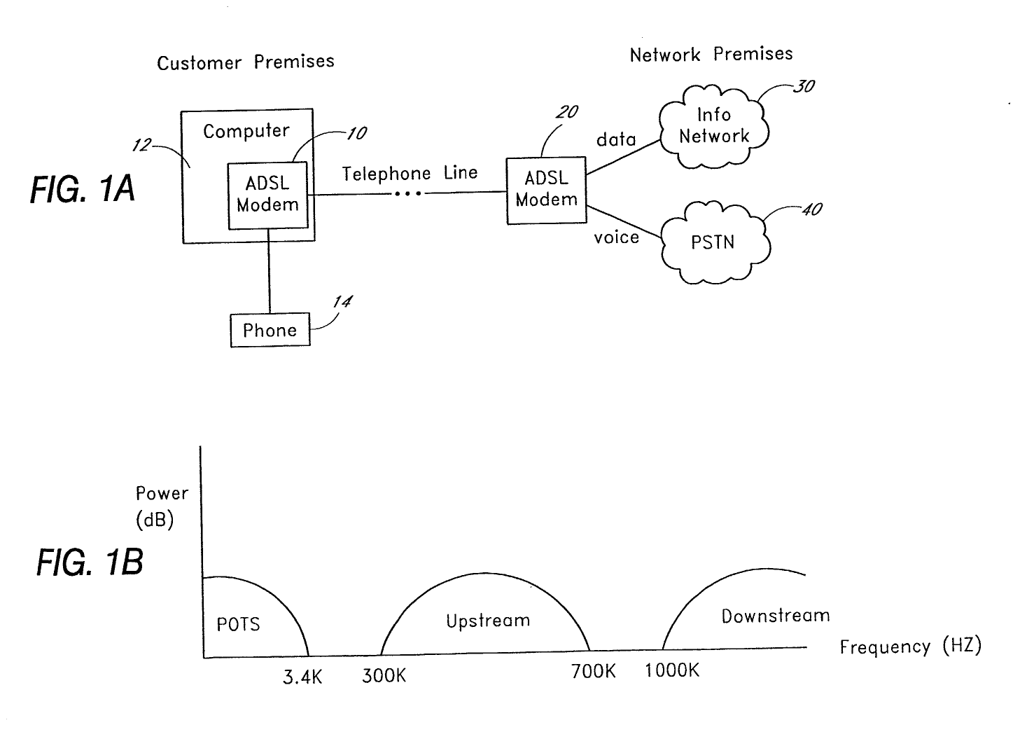

An ADSL system permits simultaneous transmission of data and voice over the same telephone line. FIG. 1A illustrates a typical ADSL system. Data from an information network 30 such as the Internet and a voice signal (Plain Old Telephone Signal; POTS) from a Public Switched Telephone Network (PSTN) 40 are input to a network ADSL modem 20. The network ADSL modem 20 performs a Frequency Division Multiplexing (FDM) and transmits the multiplexed signal to a customer premises through a telephone line. At the customer premises, a user ADSL modem 10 splits the data and the voice signal. Also, the user ADSL modem 10 processes and directs the voice signal to a telephone 14 and directs data signal to a computer 12.

In the ADSL system, since a voice signal and a data signal are frequency multiplexed, they do not overlap each other. Therefore, data and voice signals can be simultaneously transmitted over a single telephone line. Also, the ADSL communication uses different frequency bands for uploading and downloading data signals. For example, upstream data uses 300-700 kHz and downstream data uses 1000 kHz- as shown in FIG. 1B. The upstream and downstream data do not overlap, either.

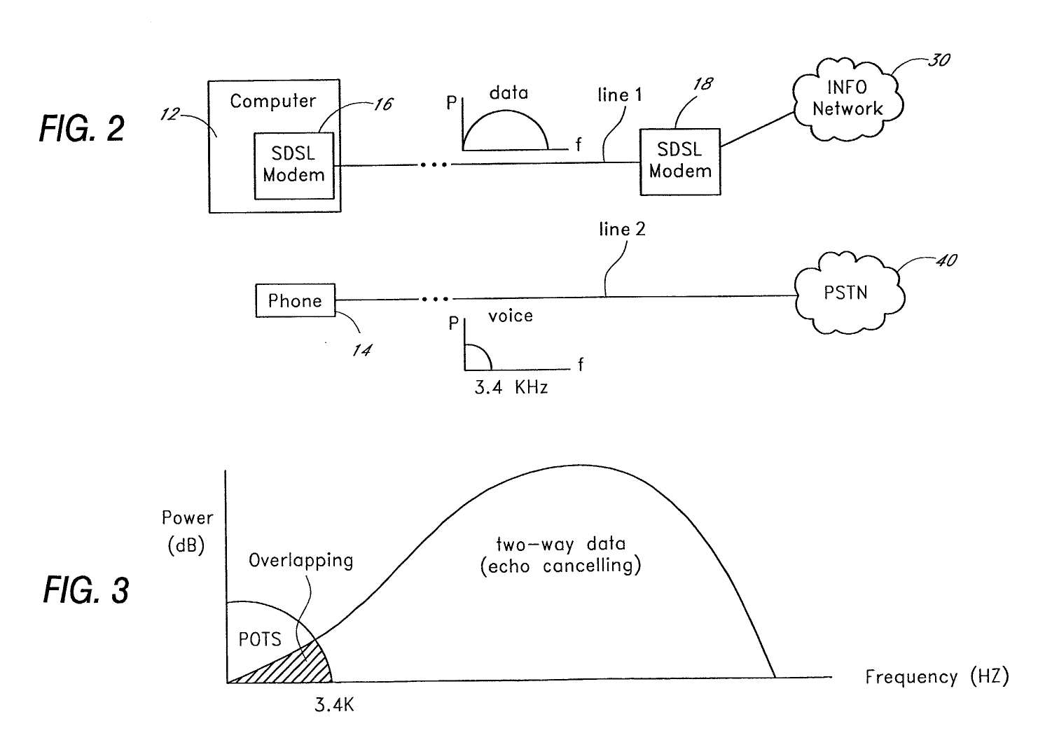

FIG. 2 illustrates a typical SDSL system. The SDSL system also connects a customer premises and a network premises through a telephone line labeled line 1. The SDSL system includes a user SDSL modem 16 and a network SDSL modem 18. A single frequency band is used for both downstream and upstream transmissions in the SDSL system. An echo cancellation is needed to enable two-way transmissions of signals without interference.

As shown in FIG. 3, the frequency of the data signal for transmission in a typical SDSL system ranges from about 0 Hz. Interference may occur when this SDSL signal is transmitted along with a regular telephone voice signal via a single transmission line. This is because in the public telephone network, the voice signal transmission band is 0-3.4 kHz and the SDSL transmission frequencies overlap the voice signal transmission band. For SDSL, thus, another telephone line (labeled line 2) is needed for a voice transmission.

According to one feature of the present invention, the interference between the data signal transmission and the voice or audio signal transmission is avoided or reduced. The data signals for transmission at frequencies overlapping the frequencies of the voice or audio signal transmission are processed before transmission. For example, the data signals loaded at the overlapping or interfering frequencies are substantially reduced, removed or cut out before its transmission such that the processed data signals do not substantially interfere with the voice or audio signals. Alternatively, the data signals loaded at the overlapping or interfering frequencies are shifted to another frequency range which does not overlap or interfere with the voice or audio signals. With the processing of the data signals before transmission, data signals and audio signals can be transmitted along a single transmission line substantially without interference. Applying this to the SDSL transmission, the SDSL system does not require two separate telephone lines for data and voice signal transmissions.

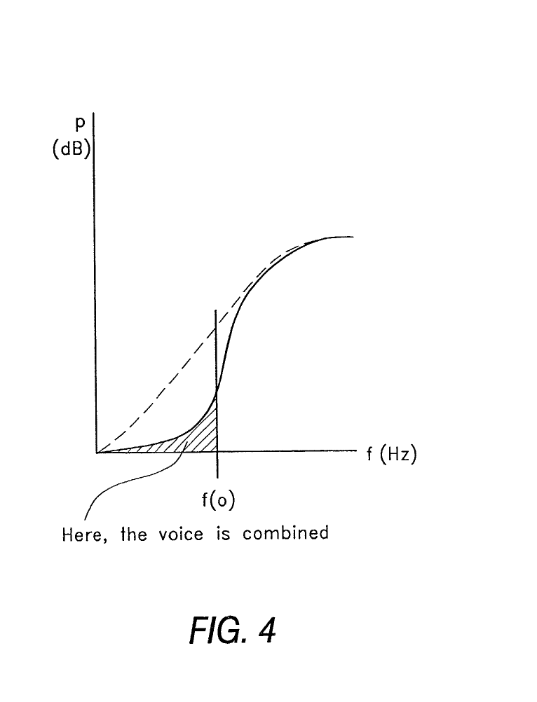

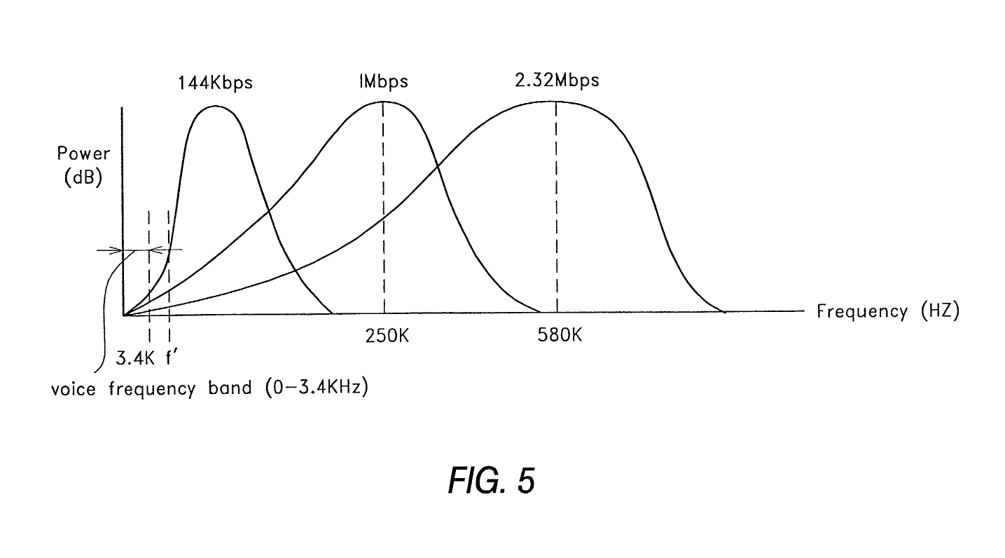

FIG. 4 illustrates a conceptual power reduction of data signals at low frequencies. Although the processing of the data before transmission here is described in terms of power reduction, the application of the present invention is not limited thereto. The dotted line represents a power distribution of a regular SDSL data transmission over frequency whereas the solid line represents a power distribution of a processed data signal according to one example of the present invention. The power of the data to be transmitted at frequencies below a frequency f(0) is substantially reduced. For the sake of convenience, the frequency f(0) is hereinafter referred to as a “cut-off frequency”. In principle, the processed data with substantially low power below the cut-off frequency can be transmitted along with another signal such as a voice signal at frequencies below the cut-off frequency without substantial interference therebetween.

It is important that the process of reduction, removal or cutting of the data signals do not significantly affect the quality of the transmission. The extent of the processing of reducing, removing or cutting of certain data signals below the cut-off frequency is such that the processed data signals do not substantially interfere with the voice or audio signal transmission and that the processed data signals can be substantially reproduced after transmission. The cut-off frequency is determined mainly in view of the reproducibility of the processed data signal upon receipt. The cut-off frequency is as low as 3.4 kHz, which is the high end frequency of the voice or audio signal transmission in the public telephone network. The cut-off frequency can be as high as or as low as a frequency, the transmission above which would not entail reproducibility problem of the data upon receipt.

Referring to FIG. 5, the determination of the cut-off frequency is further discussed. Power distribution spectrums of a DSL system at three different transmission rates, namely at 144 kbps, 1 Mbps and 2.32 Mbps, are shown. The shape and the height of the power distributions do not represent actual distribution of transmissions; rather, these spectrums conceptually illustrate the power distribution at different transmission rates. The power of the data transmission is distributed over frequency from about 0 Hz to a certain frequency depending upon the transmission rate as in FIG. 5. Among the spectrums of the three transmission rates, the power of the 144 kbps transmission is distributed over the narrowest frequency band. The power of the 1 Mbps transmission is spread over a broader range of frequencies, and the transmission at 2.32 Mbps uses even a broader frequency range than the 1 Mbps transmission. The power of transmission at frequencies below a reference frequency f′ in the 144 kbps transmission is higher than those in the 1 Mbps and 2.32 Mbps transmissions.

The more the data is reduced, removed or cut out in the processing before transmission, the harder the reproduction after the transmission. Thus, the cut-off frequency in a lower rate transmission like the 144 kbps transmission is determined to be lower than a higher rate transmission like the 1 Mbps and 2.32 Mbps transmissions. In the 144 kbps transmission, the cut-off frequency is from about 500 Hz to about 7 kHz. Preferably, the cut-off frequency for the 144 kbps transmission is from about 700 Hz to about 5 kHz, more preferably, from about 1 kHz to about 4 kHz. In the 1 Mbps transmission, the cut-off frequency is about 3.4 kHz to about 10 kHz. Preferably, the cut-off frequency for the 1 Mbps transmission is from about 4 kHz to about 7 kHz, more preferably, from about 4 kHz to about 5 kHz. In the 2.32 Mbps transmission, the cut-off frequency is about 3.4 kHz to about 20 kHz. Preferably, the cut-off frequency for the 2.32 Mbps transmission is from about 5 kHz to about 15 kHz, more preferably, from about 7 kHz to about 12 kHz. In any transmission rate, the cut-off frequency for reduction, removal, or cutting of the data is determined from a range of about 0.5 kHz to about 20 kHz, preferably about 3.4 kHz to about 15 kHz, and more preferably about 4 kHz to about 12 kHz. Although ranges of the cut-off frequencies are provided, the cut-off frequency is not limited thereto. The ranges of the cut-off frequency may be broadened in an application using various techniques for restoring lost data during transmission or the like.

Given the cut-off frequency for the processing, the extent of the power reduction, removal or cutting is determined in view of the permissible interference between the processed data and the voice or audio signal to be transmitted along the same transmission line. The power at frequencies below the cut-off frequency after the processing should be sufficiently lowered so that the transmission of data signal may not cause substantially audible noises along the transmission line. Particularly, the data signal corresponding to the frequency range audible to human, 20-20,000 Hz, is substantially lowered to avoid such noises. The level of remaining power at the frequencies below the cut-off frequency is kept as low as about −30 dBm (decibels above 1 milliwatt). Preferably, the power remaining at the frequencies below the cut-off frequency after processing is below about −40 dBm, more preferably below about −50 dBm. Further, the reduction of the power can be characterized in terms of the ratio of the power before and after the processing of reduction, removal or cutting. The processing reduces the power level of the data to be transmitted at frequencies below the cut-off frequency from about 3 dB to about 80 dB of the original power. Preferably, the power reduction is from about 10 to about 70 dB, more preferably, from about 20 dB to about 70 dB.

With the processing of the reduction, removal or cutting, the data signal to be transmitted has a substantially low power remaining at frequencies below the cut-off frequency, as illustrated in FIG. 4. Thus, the processed data signal can be transmitted with another signal having a transmission frequency range below the cut-off frequency without substantial interference. Particularly, the processed data signal can be transmitted along with a voice or audio signal of telephone conversation in a single telephone line. Also, the cut-off frequency for the processing is determined such that the processed data can be substantially reproduced upon receipt. Therefore, the present invention, with the selection of appropriate cut-off frequency and the level of reduction, removal or cutting of the data signal, provides a communication system, which allows simultaneous transmission of a data signal and a voice/audio signal. Further, as will be seen with various applications of the present invention, the data signal as well as the voice/audio transmission is two-way (uploading and downloading) transmitted through a single transmission line.

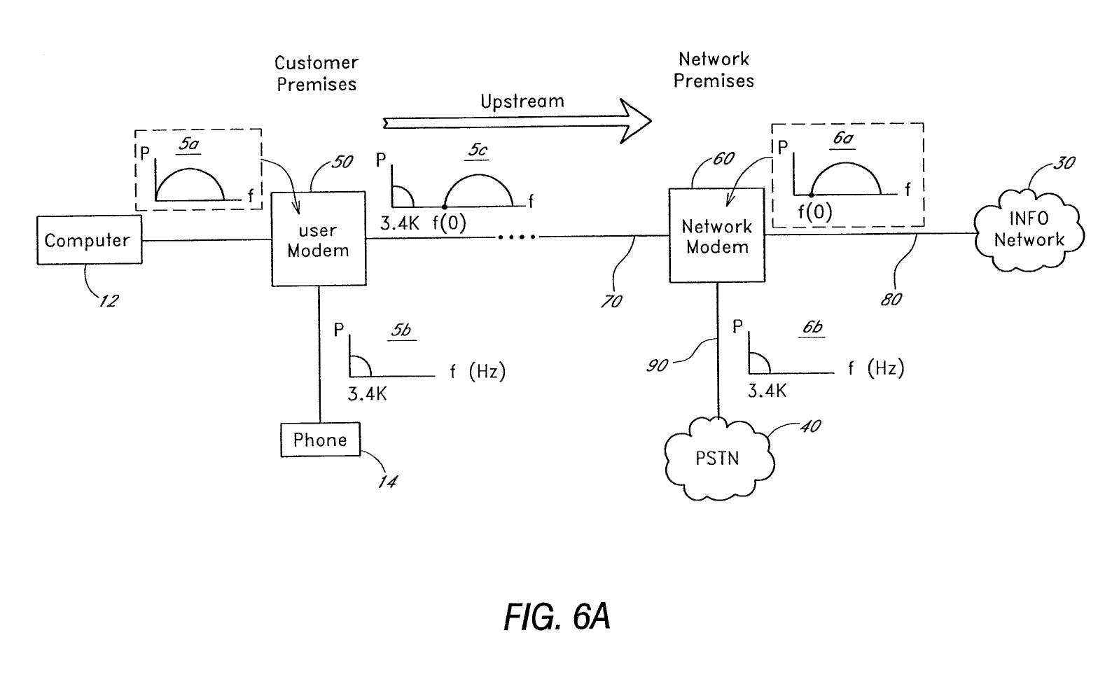

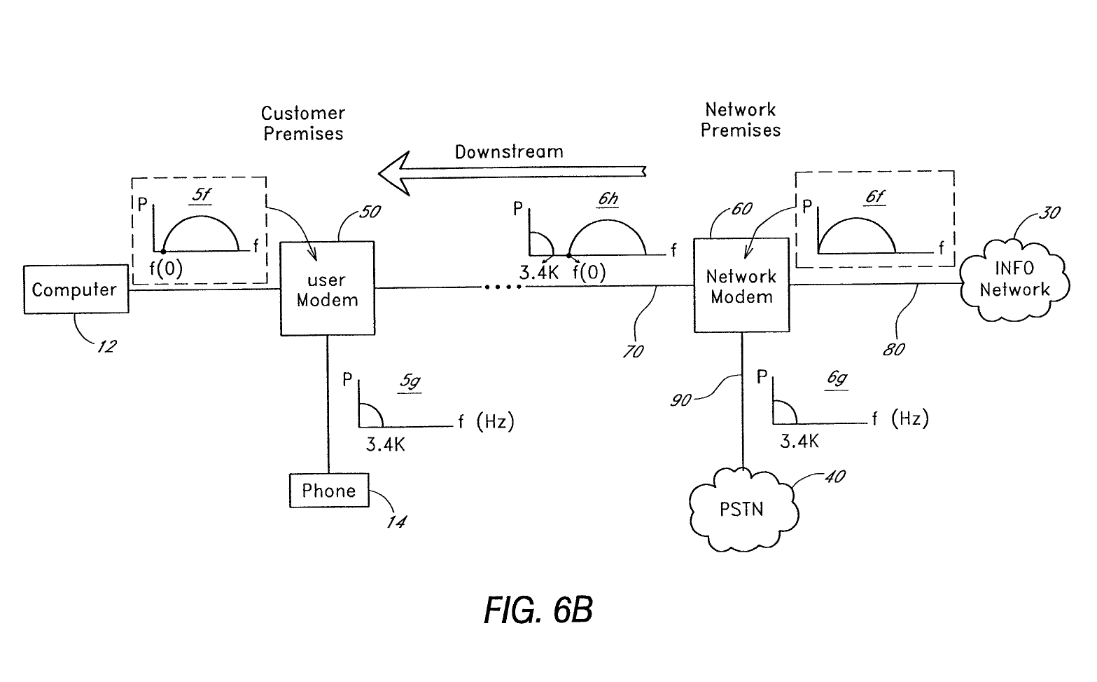

Now various embodiments and applications of the present invention will be discussed with reference to the drawings. FIGS. 6A to 8B relate to a method to transmit the voice and data simultaneously by cutting off the frequency components of the data signal having a lower than f(0) and combining the voice signal in the cut off portion.

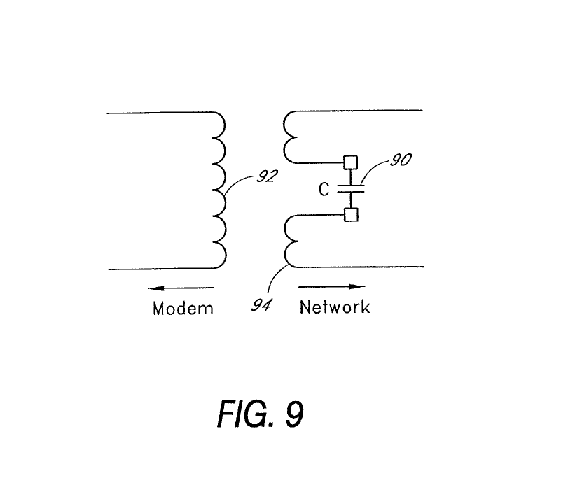

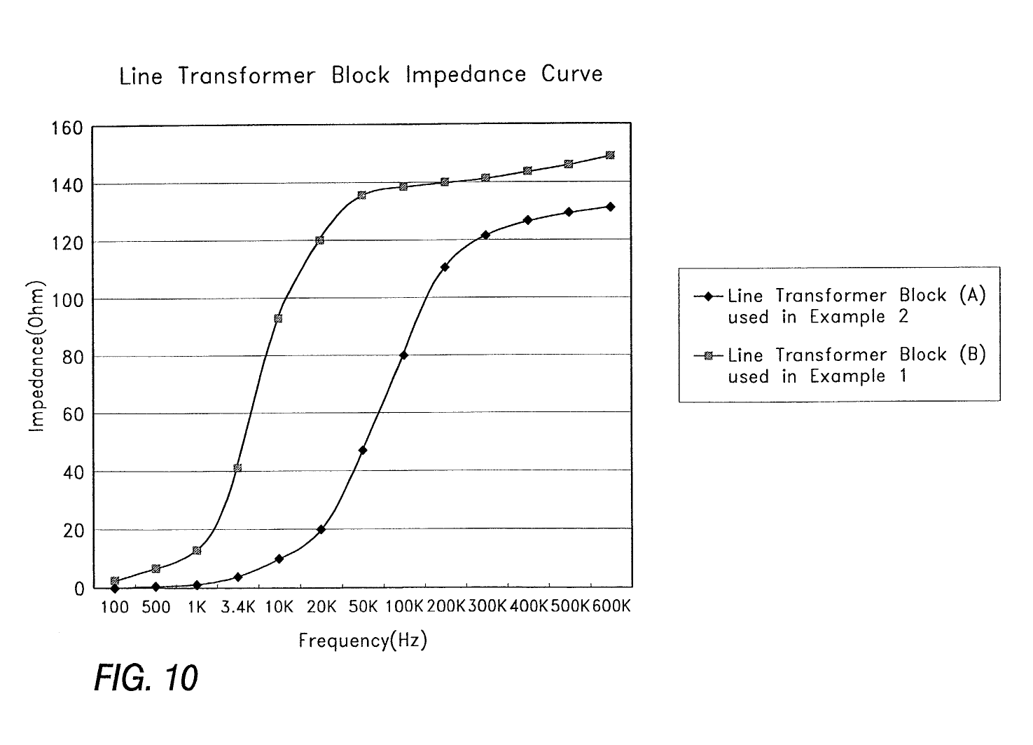

FIGS. 9 and 10 relate to a method to transmit the voice and data simultaneously by reducing the frequency components of the data signal having a lower than f(0) and combining the voice signal in the reduced portion.

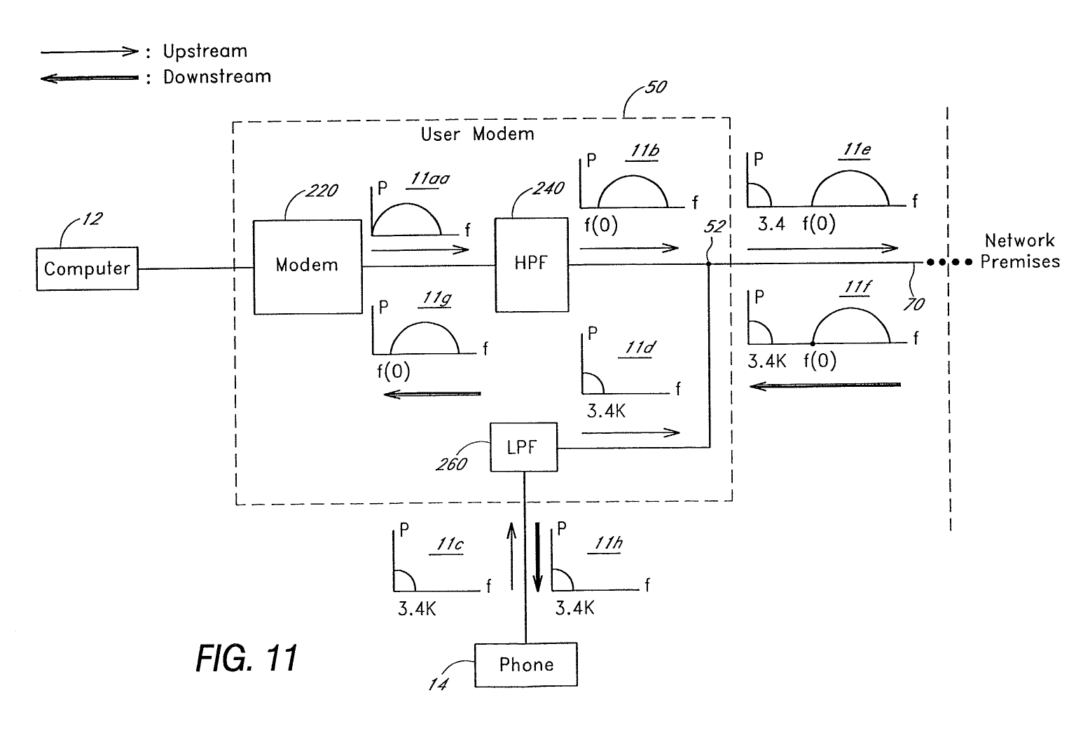

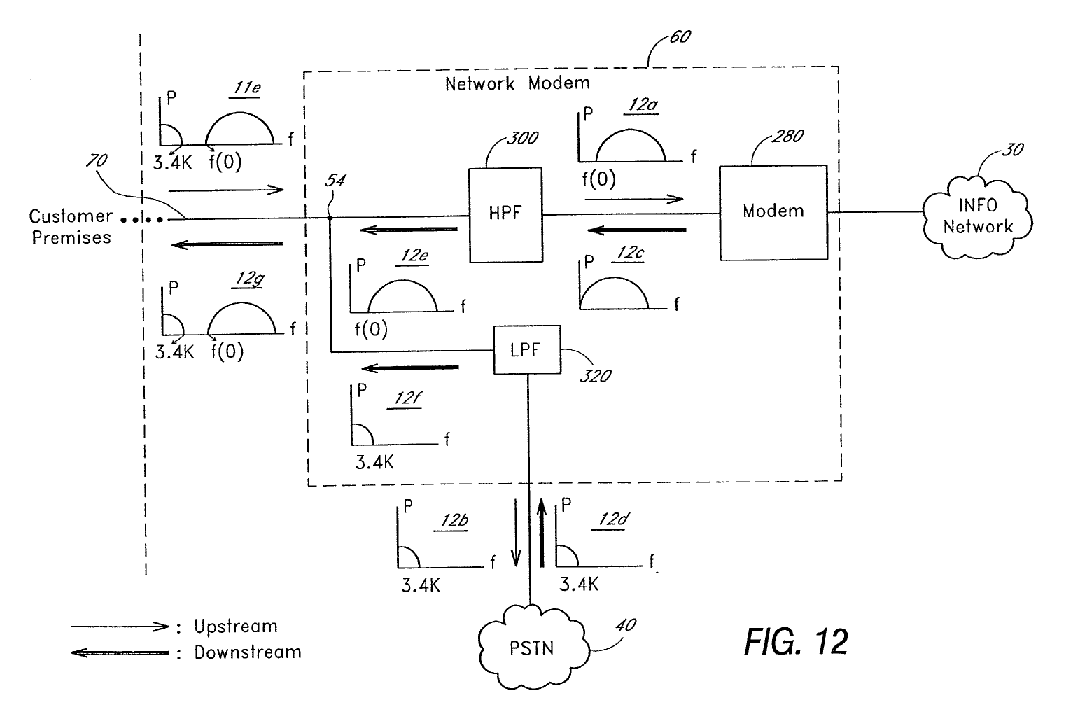

FIGS. 11 and 12 relate to a method to transmit the voice and data simultaneously by cutting off or reducing the frequency components of the data signal having a lower than f(0) and combining the voice signal in the cut off or reduced portion.

A method related to shifting a whole signal will not be explained here, since the same principle can be applied thereto.

FIGS. 6A and 6B relate to upstream and downstream transmissions, respectively. The system of the invention comprises a customer premises and a network premises. The customer premises includes a user modem 50 and the network premises has a network modem 60. The network modem 60 may be installed in an apartment complex, an office building, a hotel or in a telephone office. Those two modems may have the same structure and function. The customer premises may be connected to the network premises through the telephone line 70.

Meanwhile, the network premises may include plural network modems that have same functions and structures as the network modem 60. Also, the network premises can include an interface or switches for interfacing or switching between the network modem 60 and the network having an information network 30 and a PSTN 40. The network premises can include network modems as much as the number of user modems corresponding to each network modem. Also, it is possible to allow one network modem to communicate with a certain number of user modems, for example 5 user modems.

Now, the upstream operation of the invention will be explained with reference to FIG. 6A. A data output from the computer 12 is input to the user modem 50. The data has a digital form and may include Internet and multi-media web data. The user modem 50 modulates the input data in a predetermined modulation method and generates a signal 5a with a power spectrum shown in FIG. 6A. The power spectrum of the signal 5a starts from about 0 Hz as shown in FIG. 6A as long as the modems 50 and 60 adopt 2B1Q (2 Binary 1 Quaternary) modulation and demodulation method. If the modems 50 and 60 adopt other modulation and demodulation methods such as DMT (Discrete Multi Tone) and CAP (Carrierless Amplitude Phase), the power spectrum of the modulated signal may start from about hundreds of kHz. Also, the frequency distribution of the power spectrum depends on the communication speed of the modem as mentioned above. That is, the faster the speed is, the broader the frequency range. Meanwhile, the computer 12 can include any kinds of computing device such as a laptop computer, a settop box, and a network access device, etc. Then, the user modem 50 cuts off the components, in the signal 5a, having a lower frequency than a predetermined frequency f(0) and outputs the remaining components of the signal 5a over the telephone line 70.

Meanwhile, a user or a customer can use a telephone 14 while he is using the user modem 50 of the computer 12. Then, the voice of the user is changed to an electrical signal on the telephone 14 and it is output as a form of a voice signal 5b from the telephone 14. The voice signal 5b is input to the user modem 50. The user modem 50 cuts off the components, in the input voice signal 5b, having higher frequencies than the predetermined frequency f(0) and outputs the remaining components of the voice signal 5b.

The user modem combines the remaining components of the signal 5a and the remaining components of the voice signal 5b and outputs a combined signal 5c. The combined signal 5c is transmitted to the network premises through the telephone line 70. Of course, if the customer is using either the computer 12 or the telephone 14, either the remaining components of the signal 5a or the remaining components of the voice signal 5b will be transmitted to the network premises.

At the network premises, the network modem 60 receives the combined signal 5c transmitted from the customer premises. The network modem 60 cuts off the components, in the transmitted signal 5c, having lower frequencies than the predetermined frequency f(0) and generates a signal 6a with a power spectrum shown in FIG. 6A. The signal 6a does not include the voice signal portion any more. The network modem 60 demodulates the signal 6a in a method corresponding to the modulation of the user modem 50 and generates a digital data suitable for processing in the information network 30 such as the Internet. The digital data is transmitted to the information network 30 through, for instance, an exclusive leased line 80.

Meanwhile, the network modem 60 cuts off the components, in the transmitted signal “5c, having higher frequencies than the predetermined frequency f(0), and outputs the remaining portion 6b of the signal 5c to the PSTN 40 through a telephone line 90. It can be seen that the data portion has been removed from the signal 5c.

Now, the downstream operation of the invention will be explained with reference to FIG. 6B. A data which is transmitted on the information network 30 is input to the network modem 60. Here, the data has also a digital form and may include Internet and multi-media web data. The network modem 60 modulates the digital data in a predetermined modulation method and creates a signal 6f with a power spectrum shown in FIG. 6B. Then, the network modem 60 cuts off the components, in the signal 6f, having lower frequencies than a predetermined frequency f(0), and outputs the remaining components of the signal 6f over the telephone line 70.

A voice signal 6g having a power spectrum shown in FIG. 6B is transmitted on the PSTN 40 and is input to the network modem 60. The network modem 60 cuts off the components, in the input voice signal 6g, having higher frequencies than the predetermined frequency f(0) and outputs the remaining components of the input voice signal 6g over the telephone line 70.

The remaining components of the signal 6f and the remaining components of the input voice signal 6g are combined in the network modem 60 and the combined signal 6h is transmitted to the customer premises through the telephone line 70.

At the customer premises, the combined signal 6h is input to the user modem 50. The user modem 50 cuts off the components, in the input signal 6h, having lower frequencies than the predetermined frequency f(0) and generates a signal 5f that does not have the voice signal portion (0-f(0) Hz). The user modem 50 demodulates the signal 5f in a method corresponding to the modulation of the network modem 60 and generates a digital data suitable for processing in the computer 12. The user modem 50 outputs the digital data to the computer 12.

The user modem 50 also cuts off the components, in the input signal 6h, having higher frequencies than the predetermined frequency f(0), and outputs the remaining portion 5g to the telephone 14. It can be seen that, the data portion having higher than a frequency f(0) has been removed from the signal 6h.

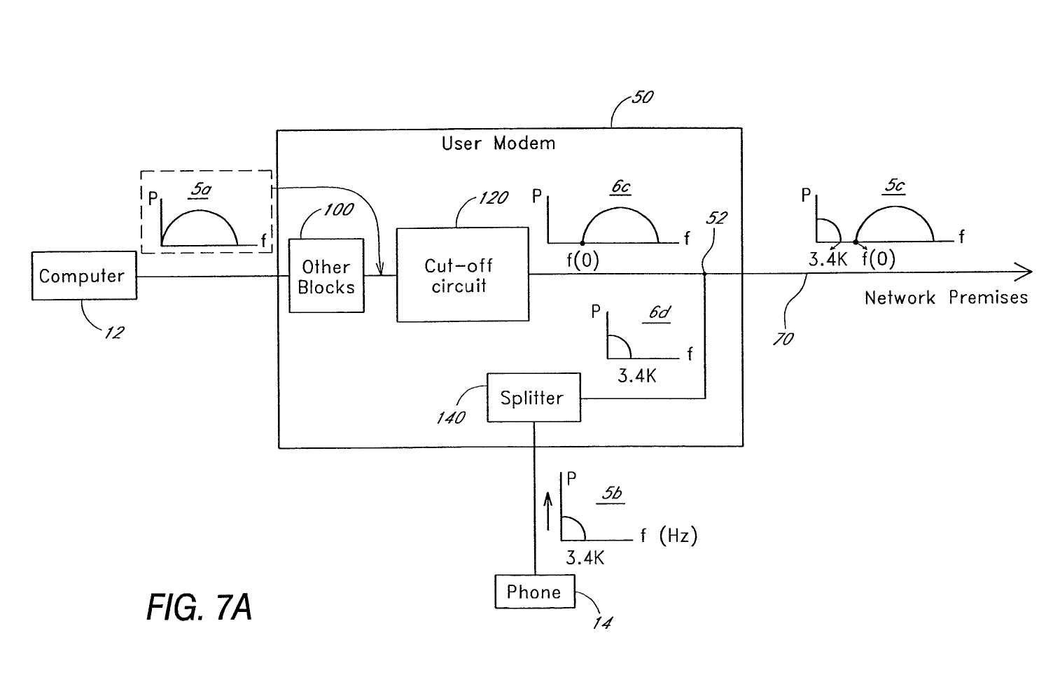

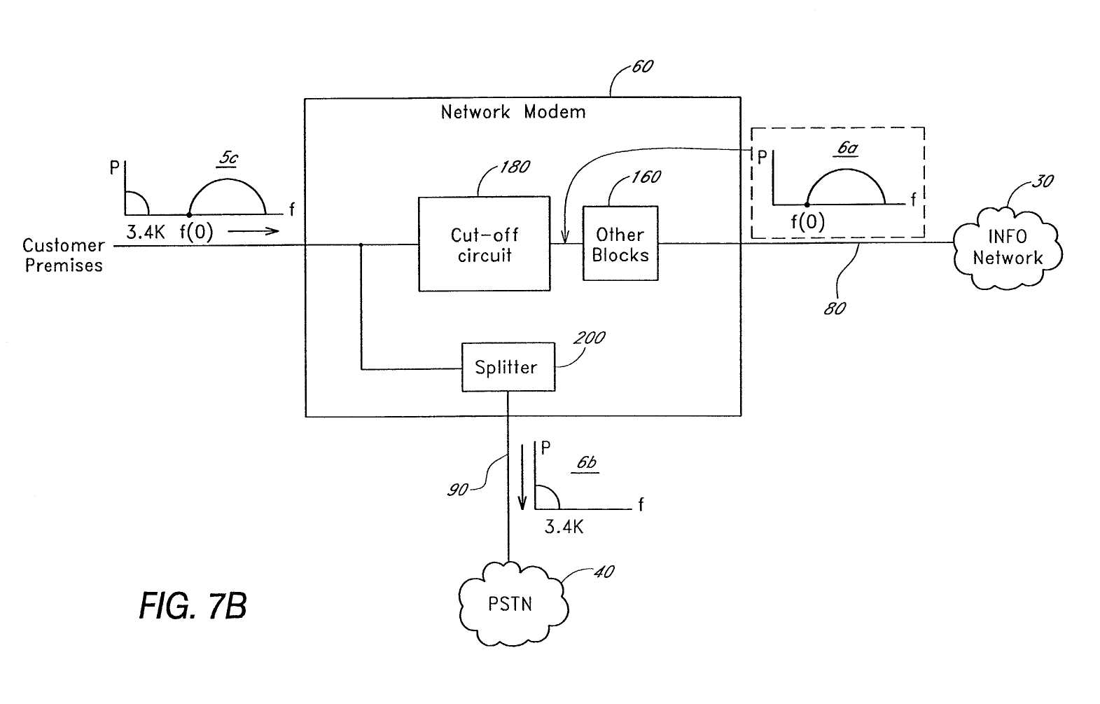

FIG. 7A is a block diagram of the user modem 50 according to one embodiment of the invention. The user modem 50 includes an other blocks 100, a cut-off circuit 120 and a splitter 140. The other blocks 100 may include a modulation block and an echo cancellation block (both not shown). The modulation block modulates an input data from the computer 12 in a predetermined way among known modulation ways such as 2B1Q, DMT and CAP, etc., and outputs a signal 5a with a power spectrum shown in FIG. 7A to the cut-off circuit 120. The echo cancellation block removes an echo that the receiver (not shown) of the user modem 50 has received after the transmitter (not shown) of the user modem 50 has transmitted a signal to the network premises. Here, the echo means a secondary signal generated in the receiver of the user modem 50 by reflection of the transmitted signal. The echo includes a near end echo and a far end echo. The near end echo is an echo that has been reflected at the transmitter of the user modem 50 and returned to the receiver of the user modem 50. The far end echo is an echo that has been reflected over the telephone line 70 and returned to the receiver of the user modem 50. If the echo is not removed from the receiver of the user modem 50 after the transmitter of the user modem 50 has transmitted a signal, the receiver may experience an interference between the signal being received from the network premises and the echo. That is, the echo is a non-preferable signal to be removed in order to enable two-way transmission of signals in the same transmission line.

The cut-off circuit 120 cuts off the components, in the signal 5a input from the other blocks, having lower frequencies than the predetermined frequency f(0). The cut-off circuit 120 outputs a signal 6c having a power spectrum shown in FIG. 7A over the telephone line 70. It can be seen that the signal 6c does not include the components having lower frequencies than the frequency f(0) any more. Here, the cut-off circuit 120 can include a High Pass Filter (HPF), whose cutoff frequency is f(0), and a line transformer block (will be explained later). Also, the cut-off circuit 120 can include any circuit, blocks and a combination thereof that can perform substantially the same function as that of the cut-off circuit 120. Also, the cut-off circuit 120 can be incorporated into the user modem 50 or can be implemented outside the user modem 50.

Meanwhile, the splitter 140 cuts off the components, in the voice signal 5b input from the telephone 14, having higher frequencies than the predetermined frequency f(0). Since the components, in the voice signal 5b, higher than f(0) generally do not exist, the splitter 140 outputs the same voice signal 6d with a frequency band of “0-3.4 kHz” to the telephone line 70. f(0) of the cut-off circuit 120 can be selected the same as or different from f(0) of the splitter 140. Here, the splitter 140 can include a Low Pass Filter (LPF), whose cutoff frequency is f(0), and any circuit, blocks and a combination thereof that can perform substantially the same function as that of the splitter 140. f(0) of the splitter 140 may be or not the same as f(0) of the cut-off circuit 120. Also, the splitter 140 can be incorporated into the user modem 50 or can be implemented outside the user modem 50.

Here, since the cut-off circuit 120 of the user modem 50 is connected to the telephone 14 through the telephone line 70, the output of the cut-off circuit 120 can be input to the telephone 14. For the frequency band higher than f(0), the output of the cut-off circuit 120 can be an extremely high frequency and may produce a strong noise signal on the telephone 14. The splitter 140 keeps the signal 6c from being input to the telephone 14. Also there can exist noise signals higher than f(0) from the telephone 14, generated in such as when a user picks up or hangs up the telephone 14. The splitter 140 prevents the noise signal higher than f(0) from being input to the cut-off circuit 120. Otherwise, the noise signal higher than f(0) output from the telephone 14 could have a deleterious effect on the user modem 50.

The signal 6c output from the cut-off circuit 120 and the voice signal 6d output from the splitter 140 are combined at the position 52 where each single input line from the cut-off circuit 120 and the splitter 140 is connected to the same telephone line 70. The combined signal 5c is transmitted to the network premises through the telephone line 70. Here, the signal 6c has already been modulated in the above mentioned modulation method in the other blocks 100 of the user modem 50 and the voice signal 6d may be a baseband signal which has not been modulated.

Now, the operation of the network modem 60 will be described by referring to FIG. 7B. The combined signal 5c transmitted from the customer premises is input to a cut-off circuit 180 of the network modem 60. The cut-off circuit 180 cuts off the components, in the input signal 5c, having lower frequencies than the predetermined frequency f(0), and outputs a signal 6 with a power spectrum shown in FIG. 7B to an other blocks 160. It can be seen that the voice portion having lower frequencies than f(0) has been removed from the input signal 5c. The other blocks 160 demodulates the signal 6a in a known method corresponding to the modulation of the user modem 50 of the customer premises and generates a digital data that is appropriate for processing in the information network 30. The other blocks outputs the digital data to the information network 30.

Similarly to the cut-off circuit 120 of the user modem 50, the cut-off circuit 180 of the network modem 60 can include a High Pass Filter (HPF), a line transformer block(will be explained later) and any circuit, blocks and a combination thereof that can perform substantially same function as that of cut-off circuit 180. Also, the cut-off circuit 180 can be incorporated into the network modem 60 or can be implemented outside the network modem 60.

The transmitted signal 5c from the customer premises is also input to the splitter 200. The splitter 200 cuts off the components, in the input signal 5c, having higher frequencies than the predetermined frequency f(0). It can be seen that the data portion having higher frequencies than f(0) has been removed from the signal 5c. The splitter 200 outputs the voice signal 6b, which is substantially the same as the voice signal 6d in the customer premises to the PSTN 40 through the telephone line 90.

Similarly to the splitter 140 of the user modem 50, the splitter 200 of the network modem 60 can include a Low Pass Filter (LPF), a line transformer block(will be explained later) and any circuit, blocks and a combination thereof that can perform substantially same function as that of the splitter 200. Also, the splitter 200 can be incorporated into the network modem 60 or can be implemented outside the network modem 60.

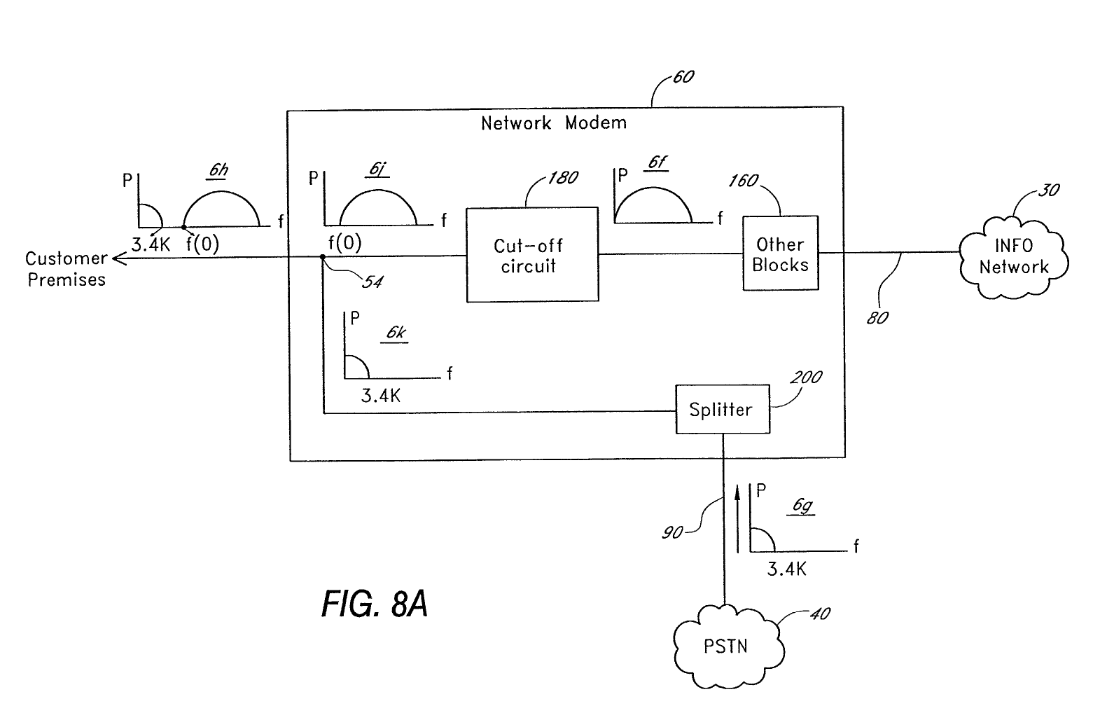

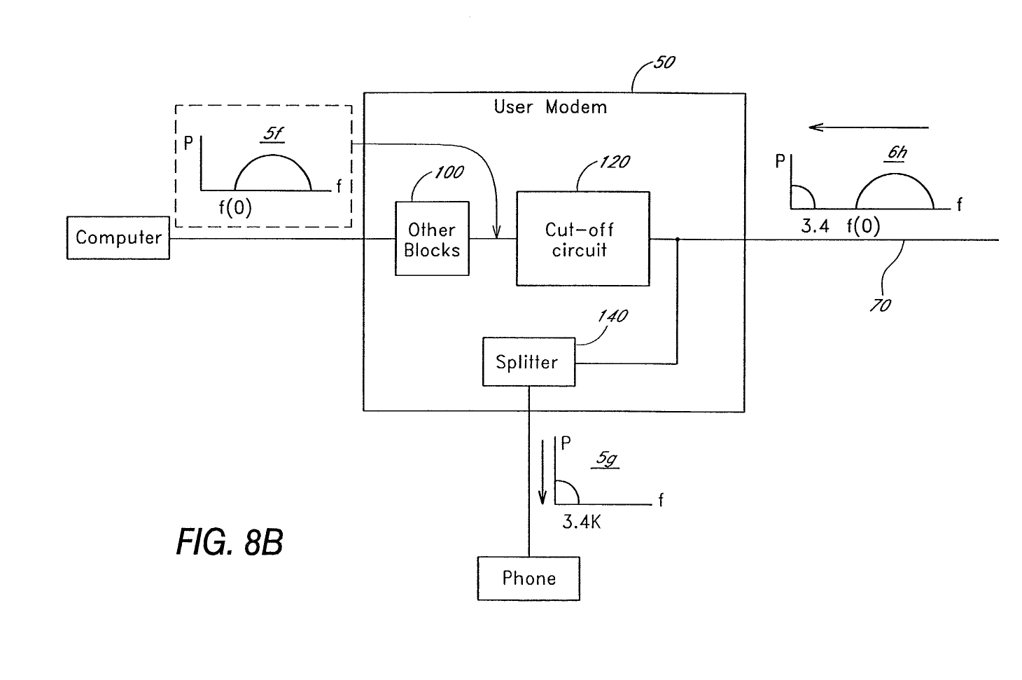

Now, the downstream operation of the invention will be explained with reference to the block diagrams of FIGS. 8A and 8B A data which is transmitted on the information network 30 is input to the other blocks 160 of the network modem 60. Here, the data has a digital form and may include Internet and multi-media web data. The other blocks 100 may include a modulation block and an echo cancellation block (both not shown). The modulation block modulates an input data from the information network 30 in a predetermined way among known modulation ways such as 2B1Q, DMT and CAP, etc., and outputs a signal 6f with a power spectrum shown in FIG. 8A to the cut-off circuit 180. The echo cancellation block removes an echo that the receiver (not shown) of the network modem 60 has received after the transmitter (not shown) of the network modem 60 has transmitted a signal to the customer premises. Here, the echo cancellation block functions substantially the same as that of the echo cancellation block of the user modem 50. Here, the echo means a secondary signal generated in the receiver of the network modem 60 by reflection of the transmitted signal to the customer premises. The echo includes a near end echo and a far end echo. The near end echo is an echo that has been reflected at the transmitter of the network modem 60 and returned to the receiver of the network modem 60. The far end echo is an echo that has been reflected over the telephone line 70 and returned to the receiver of the network modem 60. If the echo is not removed from the receiver of the network modem 60 after the transmitter of network modem 60 has transmitted a signal, the receiver may experience an interference between the signal being received from the customer premises and the echo.

The cut-off circuit 180 cuts off the components, in the input signal 6f, having lower frequencies than the predetermined frequency f(0), and outputs a signal 6j with a power spectrum shown in FIG. 8A over the telephone line 70. It can be seen that the components having lower frequencies than f(0) has been removed from the signal 6f.

The voice signal 6g which is transmitted on the PSTN 40 is input to the splitter 200. The splitter 200 cuts off the components, in the voice signal 6g, having higher frequencies than the predetermined frequency f(0) and outputs a signal 6k with a power spectrum shown in FIG. 8A. The splitter 200 also keeps the signal “6j with frequencies higher than f(0) from being input to the PSTN 40.

The signal 6j output from the other blocks 160 and the voice signal 6k output from the splitter 200 are combined at the position 54 where each single telephone line is connected to the same telephone line 70. Then, the combined signal 6h is transmitted to the customer premises through the telephone line 70.

At the customer premises, the transmitted signal 6h from the network premises is input to the cut-off circuit 120 of the user modem 50. The cut-off circuit 120 cuts off the components, in the input signal 6h, having lower frequencies than the predetermined frequency f(0), and outputs a signal 5f with a power spectrum shown in FIG. 8B to other blocks 100. It can be seen that the voice signal portion having lower frequencies than f(0) has been removed. The other blocks 100 demodulates the signal 5f data in a predetermined demodulation method corresponding to the modulation of the network modem 60 and generates a digital data suitable for the processing in the computer 12. The other blocks 100 outputs the digital data to the computer 12.

The transmitted signal 6h from the network premises is also input to the splitter 140. The splitter 140 cuts off the components, in the signal 6h, having higher frequencies than the predetermined frequency f(0). Therefore, the data portion with frequencies higher than f(0) has been removed from the signal 6h. The splitter 140 outputs substantially the same voice signal 5g as the signal 6k in the network premises to the telephone 14.

Now, a method for reducing the components having lower frequencies than the predetermined frequency f(0) or the components around f(0) with regard to a line transformer block will be explained in detail by referring to FIG. 9.

FIG. 9 shows an example circuit structure of the line transformer block according to the present invention. The line transformer block shown in FIG. 9 includes an air gap(not shown), a capacitor 90 and a coil having a first coil 92 directed towards the modem party and a second coil 94 directed towards the telephone line.

If a modem having a line transformer block supports various communication speeds, the line transformer block has wide range of frequency characteristics, for example from 144 kbps to 2.32 Mpbs. The parameters of the elements used in the line transformer block that satisfy the above requirements (supporting 144 kbps to 2.32 Mpbs.) are shown in Example 1.

EXAMPLE 1

| Elements | Parameters |
|---|---|
| Air gap | 0 mm |
| Coil tuns (1^{St}:2^{nd}) | 21:42 |
| Capacitance | 1 μF |

As shown in Example 1, the line transformer block that supports various communication speeds has no air gap, relatively high capacitance (1 μF) and many coil turns (21:42).

Referring to FIG. 10, it can be seen that the line transformer block using the parameters of Example 1 has high impedance around 10 kHz and between 3.4 and 10 kHz. Therefore, if a voice signal about 3.4 kHz or 10 kHz is combined with the output of the line transformer block, the modem having the line transformer block using the parameters of Example 1 entails reproducibility problems on recipient. Here, 3.4 kHz or 10 kHz is a frequency selected from f(0).

On the other hand, the line transformer block of the present invention is designed to support relatively high communication speeds so that the present line transformer block has a relatively narrower range of frequency characteristics, for example from 1 Mbps to 2.32 Mpbs, than the line transformer block of Example 1. The parameter sets of the elements in the present line transformer block that satisfy the above requirements are also shown in Example 2.

EXAMPLE 2

| Elements | Parameters |
|---|---|
| Air gap | 0.01-1 mm |
| Coil tuns (1^{st}:2^{nd}) | 16:32, 10:20, 8:16, 20:40, 15:50, etc. |
| Capacitance | 0.1 μF-0.001 μF |

As shown in Example 2, the line transformer block according to the invention has an air gap (0.01-1 mm), relatively lower capacitance (0.1-0.001 μF) and less coil turns (16:32, 10:20, etc.) than each parameter of the elements used in Example 1. The air gap can be made by scrubbing either the core or both the cores little by little until the gap becomes “0.01-1 mm”.

Referring to FIG. 10 (Example 2), it can be seen that the present line transformer block has a very low impedance around 10 kHz or between 3.4 and 10 kHz. Therefore, even if a voice signal about 3.4 kHz or 10 kHz is combined with the output of the line transformer block, the modem having the line transformer block using the parameters of Example 2 does not entail any reproducibility problems on recipient.

In certain embodiments of the invention, the parameters of all three elements are set as in Example 2. However, setting one or more parameters of the three elements in Example 2 can also obtain similar effect to the characteristics of Example 2 in FIG. 10. It is believed that the air gap is relatively more important than the other two elements. That is, only setting a parameter of the air gap as 0.01-1 mm may obtain the present line transformer block characteristics (Example 2 in FIG. 10). For the coil turns, there are no presently known particular rules. That is, the parameters of the coil turns in Example 2 are experimental values which can be modified so long as they satisfy the desired function of the invention.

Now, the characteristics of the line transformer block and splitter will be explained in detail. First, the characteristics of the line transformer block will be described. According to the experiment, a data and a voice can be transmitted through a single transmission line by reducing power of a signal component input to the line transformer block having a frequency range of 2-50 kHz, 3.4-20 kHz and 5-10 kHz to an amount of 3-80 dB, 10-70 dB and 20-70 dB, respectively.

Second, the characteristics of the splitter will be described. According to the experiment, a data and a voice can be transmitted through a single transmission line by reducing power of a signal component input to the splitter having a frequency range of 2-20 kHz, 3.4-15 kHz and 5-10 kHz to an amount of 1-30 dB, 3-30 dB and 10-30 dB, respectively.

FIGS. 11 and 12 are block diagrams of another embodiment of the present invention. In FIGS. 11 and 12, a single arrow represents the upstream signal flow and a bolded arrow represents the downstream signal flow. The user modem 50 includes a modem 220, a HPF (High Pass Filter) 240 and a LPF (Low Pass Filter) 260.

Now the operation of the user modem 50 will be explained by referring to FIG. 11. First, upstream operation will be described. A digital data output from the computer 12 is input to the modem 220. The modem 220 modulates the input digital data in a known method as mentioned above and outputs a signal 11a having a power spectrum shown in FIG. 11 to the HPF 240. The HPF 240 performs high pass filtering of the signal 11a and outputs a signal 11b having a power spectrum shown in FIG. 11 over the telephone line 70. Its cut off frequency is f(0) as shown in FIG. 11. Here, the HPF may have the same characteristics as that of the line transformer block mentioned above with respect to FIGS. 9 and 10.

The LPF 260 carries out low pass filtering of the input voice signal 11c and outputs a signal 11d over the telephone line 70. Its cut off frequency is also f(0). Here, the LPF 260 can be replaced with a splitter mentioned above. Similarly to the splitter, the LPF 260 keeps the data 11b from being input to the telephone 14 and prevents the signal, which is generally noise, higher than f(0) from being input to the modem 220 via the HPF 240. Meanwhile, the LPF may have the same characteristics as those of the splitter mentioned above with respect to FIGS. 9 and 10.

The signal 11b and the signal 11d are combined at the position 52 and the combined signal 11e is transmitted to the network premises through the telephone line 70.

Second, the downstream operation in the user modem 50 will be described. The downstream operation is opposite to that of the upstream operation. The transmitted signal 11f from the network premises is input to the HPF 240 and the LPF 260. The HPF 240 carries out high pass filtering of a signal 11f and outputs a signal 11g with a power spectrum shown in FIG. 11 to the modem 220. The modem demodulates the signal 11g in order to be suitable for processing in the computer 12 and outputs the demodulated signal to the computer 12. The LPF 260 carries out low pass filtering of the signal 11f and outputs a voice signal 11h with a power spectrum shown in FIG. 11 to the telephone 14.

Now, the operation of the network modem 60 will be explained with reference to FIG. 12. The network modem 60 includes a modem 280, a HPF (High Pass Filter) 300 and a LPF (Low Pass Filter) 320. Each element of the network modem 60 may carry out the same function as the one corresponding to the user modem 50.

First, the upstream operation will be described. The combined signal 11e transmitted from the customer premises is input to the HPF 300. The HPF 300 carries out high pass filtering of the input signal 11e and outputs a signal 12a with a power spectrum shown in FIG. 12 to the modem 280. The modem 280 demodulates the input signal 11a in a known method corresponding to the modulation method of the user modem 50 and outputs a digital data that is appropriate for processing in the information network 30. The digital data is transmitted to the information network 30.

The combined signal 11e transmitted from the customer premises is also input to the LPF 320. The LPF 320 carries out low pass filtering of the input signal 11e and outputs the voice signal portion 12b to the PSTN 40.

Second, the downstream operation will be described. A digital data which is transmitted on the information network 30 is input to the modem 280. The modem 280 modulates the digital data in a known method and outputs a signal 12c with a power spectrum shown in FIG. 12 to the HPF 300. The HPF 300 carries out high pass filtering of the signal 12c and outputs a filtered signal 12e over the telephone line 70.

Meanwhile, the voice signal which is transmitted on the PSTN 40 is input to the LPF 320. The LPF 320 carries out low pass filtering of the input voice signal 12d and outputs signal 12f to the telephone line 70. The signal 12e and the signal 12f are combined at the position 54 and the combined signal 12g is transmitted to the customer premises through the telephone line 70.

In FIGS. 11 and 12, the HPFs and the LPFs can be incorporated in the modems 220 and 280 or can be implemented outside the modems 220 and 280. Also, only the HPFs can be incorporated in the modems 220 and 280 or only the LPFs can be incorporated in the modems 220 and 280.

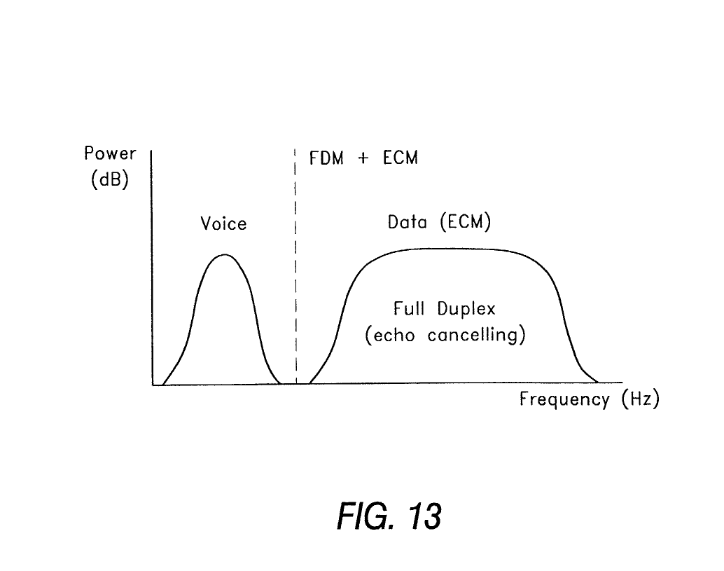

If the embodiments of the present invention are applied to the modem systems that require an echo cancellation, a data and a voice signal can be transmitted through the single transmission line by combination of the echo cancellation multiplexing (ECM) and the Frequency Division Multiplexing (FDM) as shown in FIG. 13. Combining the FDM and ECM can be performed as follows. Since the two signals having two different frequency bands are combined, the FDM is performed. Combining of ECM and FDM can be performed by combining the first signal and voice signal that have different frequency bands, respectively onto the same transmission line.

Thus, there has been described a new transmission method and apparatus together with a new modem. While the preferred embodiment of the invention has been shown, apparently many changes and modifications may be made therein without departing from the scope of the invention. For example, the present embodiments were mainly described regarding DSL modems, but those will be able to be applied to other modems or modem related apparatus as long as they satisfy the desired function of the invention. Also, since the voice signal can be reproduced even if a voice frequency that is right below 2 kHz is selected, the above mentioned predetermined frequency f(0) can be selected from a frequency of 2-50 kHz. It is appreciated, therefore, that the appended claims cover any and all such changes and modifications which do not depart from the true spirit and scope of the invention.

What is claimed is:

1. A signal processing apparatus, comprising:
a first circuit having an output terminal, the first circuit configured to receive a first signal from a modem, the first signal comprising a first frequency band and pass a component of the first signal having a higher frequency than a first predetermined frequency; and
a second circuit having an output terminal, the second circuit configured to receive a second signal comprising a second frequency band overlapping with at least a portion of the first frequency band, the second circuit configured to pass a component of the second signal having a lower frequency than a second predetermined frequency;
wherein the output terminal of the first circuit is connected to the output terminal of the second circuit.

2. A signal processing apparatus for use in telecommunication over a transmission line, the apparatus comprising:
a first circuit having an output terminal, the first circuit configured to receive a first signal from a modem, the first signal comprising a first frequency band and pass a component of the first signal having a higher frequency than a first predetermined frequency, the output terminal adapted to transmit an output signal of the first circuit over the transmission line; and
a second circuit having an output terminal, the second circuit configured to receive a second signal comprising a second frequency band overlapping with at least a portion of the first frequency band, the second circuit configured to pass a component of the second signal having a lower frequency than a second predetermined frequency;
wherein the output terminal of the first circuit is connected to the output terminal of the second circuit.

3. The apparatus of claim 2, further comprising a modem and wherein the output of the modem is connected to the first circuit.

4. The apparatus of claim 3, wherein the modem comprises a Symmetric Digital Subscriber Line modem.

5. The apparatus of claim 3, wherein the first circuit is incorporated into the modem.

6. The apparatus of claim 5, wherein the first circuit comprises a line transformer that has an air gap.

7. The apparatus of claim 6, wherein the size of the air gap is 0.01-1 mm.

8. The apparatus of claim 6, wherein the line transformer has a capacitor whose capacitance is 0.1 μF-0.001 μF.

9. The apparatus of claim 2, wherein the first predetermined frequency is between 2 kHz and 50 kHz.

10. The apparatus of claim 2, wherein the first circuit is configured to substantially reduce power of the component of the first signal sufficient to avoid interference with the second signal.

11. The apparatus of claim 10, wherein the first circuit is configured to reduce power of a component of the first signal having a frequency range of 2-50 kHz to an amount of 3-80 dB.

12. The apparatus of claim 10, wherein the first circuit is configured to reduce power of a component of the first signal having a frequency range of 3.4-20 kHz to an amount of 10-70 dB.

13. The apparatus of claim 10, wherein the first circuit is configured to reduce power of a component of the first signal having a frequency range of 5-10 kHz to an amount of 20-70 dB.

14. The apparatus of claim 2, wherein the first circuit is configured to cut off substantially power of all voice frequencies of the first signal.

15. The apparatus of claim 2, wherein the first circuit comprises a High Pass Filter.

16. The apparatus of claim 2, wherein the second predetermined frequency is between 2 kHz and 20 kHz.

17. The apparatus of claim 2, wherein the second circuit is configured to substantially reduce power of the component of the second signal sufficient to avoid interference with the first signal.

18. The apparatus of claim 17, wherein the second circuit is configured to reduce power of a component of the second signal having a frequency range of 2-20 kHz to an amount of 1-30 dB.

19. The apparatus of claim 17, wherein the second circuit is configured to reduce power of a component of the second signal having a frequency range of 3.4-15 kHz to an amount of 3-30 dB.

20. The apparatus of claim 17, wherein the first circuit is configured to reduce power of a component of the second signal having a frequency range of 5-10 kHz to an amount of 10-30 dB.

21. The apparatus of claim 2, wherein the second circuit is configured to cut off power of a component of the second signal higher than the second predetermined frequency.

22. The apparatus of claim 2, wherein the second circuit is configured to cut off substantially power of all non-voice frequencies of the second signal.

23. The apparatus of claim 2, wherein the first predetermined frequency is the same as the second predetermined frequency.

24. The apparatus of claim 2, further comprising a modem and wherein the first and second circuits are incorporated into the modem.

25. The apparatus of claim 24, wherein the output terminals of the first and second circuits are connected outside the modem.

26. The apparatus of claim 24, wherein the modem comprises a Symmetric Digital Subscriber Line modem.

27. The apparatus of claim 2, wherein the second circuit comprises a Low Pass Filter.

28. The apparatus of claim 2, wherein the second circuit comprises a splitter.

29. The apparatus of claim 2, wherein the apparatus is configured to support a communication speed faster than a predetermined speed.

30. The apparatus of claim 2, wherein the predetermined speed is 1 MHz.

31. The apparatus of claim 2, wherein the first circuit is directly connected to the second circuit.

32. A method of processing data and voice signals for transmitting via a transmission line, the method comprising:
receiving a data signal comprising a first frequency band;
receiving a voice signal comprising a second frequency band overlapping with at least a portion of the first frequency band;
passing a component of the data signal, the component having a higher frequency than a first predetermined frequency;
passing a component of the voice signal, the component having a lower frequency than a second predetermined frequency; and
combining the components of the data and voice signals onto the transmission line.

33. The method of claim 32, further comprising receiving a signal having a voice component and a data component from the transmission line, cutting off the voice component, and outputting the data component to a computing device.

34. The method of claim 32, further comprising receiving a signal having a voice component and a data component from the transmission line, cutting off the data component, and outputting the voice component to a telephone.

35. The method of claim 32, further comprising receiving a signal having a voice component and a data component from the transmission line, cutting off the voice component, and outputting the data component to an information network.

36. The method of claim 32, further comprising receiving a signal having a voice component and a data component from the transmission line, cutting off the data component, and outputting the voice component to a Public Switched Telephone Network (PSTN).

37. The method of claim 32, wherein the first predetermined frequency is between 3.4 kHz and 20 kHz.

38. The method of claim 32, wherein the passing the first component comprises reducing power of a component of the data signal sufficient to avoid interference with the second signal.

39. The method of claim 32, wherein the passing the first component comprises reducing power of a component of the data signal having a frequency range of 2-50 kHz to an amount of 3-80 dB.

40. The method of claim 32, wherein the passing the first component comprises reducing power of a component of the data signal having a frequency range of 3.4-20 kHz to an amount of 10-70 dB.

41. The method of claim 32, wherein the passing the first component comprises reducing power of a component of the data signal having a frequency range of 5-10 kHz to an amount of 20-70 dB.

42. The method of claim 32, wherein the passing the first component comprises cutting off a component of the data signal lower than the first predetermined frequency.

43. The method of claim 32, wherein the passing the second component comprises reducing power of a component of the voice signal sufficient to avoid interference with the data signal.

44. The method of claim 43, wherein the passing the second component comprises reducing power of a component of the voice signal having a frequency range of 2-20 kHz to an amount of 1-30 dB.

45. The method of claim 43, wherein the passing the second component comprises reducing power of a component of the voice signal having a frequency range of 3.4-15 kHz to an amount of 3-30 dB.

46. The method of claim 43, wherein the passing the second component comprises reducing power of a component of the voice signal having a frequency range of 5-10 kHz to an amount of 10-30 dB.

47. The method of claim 32, wherein the passing the second component comprises cutting off a component of the voice signal higher than the second predetermined frequency.

48. The communication system, comprising:
a transmission line having first and second terminals;
a first terminal device connected to the first terminal of the transmission line; and
a second terminal device connected to the second terminal of the transmission line;
wherein the first terminal device comprises first and second circuits,
wherein the first circuit has an output terminal, is configured to receive a first signal comprising a first frequency band and pass a component of the first signal having a higher frequency than a first predetermined frequency;
and wherein the second circuit has an output terminal, and is configured to receive a second signal comprising a second frequency band overlapping with at least a portion of the first frequency band, and to pass a component of the second signal having a lower frequency than a second predetermined frequency.

49. The communication system of claim 48, wherein the second terminal device comprises a first circuit and a second circuit,
wherein the first circuit has an output terminal, and is configured to receive a first signal comprising a first frequency band and pass a component of the first signal having a higher frequency than a first predetermined frequency,
wherein the second circuit has an output terminal, is configured to receive a second signal comprising a second frequency band overlapping with at least a portion of the first frequency band, and to pass a component of the second signal having a lower frequency than a second predetermined frequency,
and wherein the output terminal of the first circuit is connected to the output terminal of the second circuit.

50. The communication system of claim 48, wherein the first circuit is configured to substantially reduce power of the component of the first signal sufficient to avoid interference with the component of the second circuit.

51. The communication system of claim 48, wherein the first circuit is configured to reduce power of a component of the first signal having a frequency range of 2-50 kHz to an amount of 3-80 dB.

52. The communication system of claim 48, wherein the first circuit is configured to reduce power of a component of the first signal having a frequency range of 3.4-20 kHz to an amount of 10-70 dB.

53. The communication system of claim 48, wherein the first circuit is configured to reduce power of a component of the first signal having a frequency range of 5-10 kHz to an amount of 20-70 dB.

54. A communication method in a communication system including a transmission line having first and second terminals, a first terminal device connected to the first terminal of the transmission line and a second terminal device connected to the second terminal of the transmission line, the method comprising:
receiving a first signal comprising a first frequency band;
receiving a second signal comprising a second frequency band overlapping with at least a portion of the first frequency band;
passing a component of the first signal, the component having a higher frequency than a first predetermined frequency;
passing a component of the second signal, the component having a lower frequency than a second predetermined frequency;
combining the components of the first and second signal; and
transmitting the combined components to the one of the first and second terminal devices through the transmission line.
